(19) United States
(12) Patent Application Publication
(10) Pub. No.: US 2017/0160572 A1
(43) Pub. Date: Jun. 8, 2017

(54) METHOD OF PRODUCING DISPLAY PANEL

(71) Applicant: Sharp Kabushiki Kaisha, Sakai City, Osaka (JP)

(72) Inventor: Katsuhiro YAMAGUCHI, Sakai City (JP)

(73) Assignee: Sharp Kabushiki Kaisha, Sakai City, Osaka (JP)

(21) Appl. No.: 15/323,445

(22) PCT Filed: Aug. 18, 2015
(86) PCT No.: PCT/JP2015/073071

§ 371 Date: Jan. 3, 2017

(30) Foreign Application Priority Data
Aug. 25, 2014 (JP) 2014-170436

(51) Int. Cl. G02F 1/1333; B08B 7/00; B08B 3/00; B08B 1/04; B08B 3/02; G02F 1/1335; B08B 1/00

(52) U.S. Cl. CPC G02F 1/1333; G02F 1/133528; B08B 7/0035; B08B 1/002; B08B 1/04; B08B 3/02; B08B 3/00; G02F 2001/1316

(57) ABSTRACT

A method of producing a liquid crystal panel 11 includes a wet cleaning step, a plasma cleaning step, and a polarizing plate bonding step. The wet cleaning step is for cleaning outer surfaces 11a1 and 11bq of a CF board 11a and an array board 11b through wet cleaning. The plasma cleaning step that is performed at least before or after the wet cleaning step for cleaning the outer surfaces 11a1 and 11b1 of the CF board 11a and the array board 11b with plasma applied to the outer surfaces 11a1 and 11b1. The polarizing plate bonding step that is performed after the wet cleaning step and the plasma cleaning step is for bonding polarizing plates 11f and 11g to the outer surfaces 11a1 and 11b1 of the CF board 11a and the array board 11b.

### TECHNICAL FIELD

The present invention relates to a method of producing a display panel.

### BACKGROUND ART

A method of producing a liquid crystal panel, which is one kind of display panels, disclosed patent document 1 described below has been known. Patent document 1 discloses cleaning of glass substrates for a liquid crystal panel. A solid dielectric is disposed on at least one of opposed surfaces of opposed electrodes provided in pair in an atmosphere including 4 or higher percentage by volume of oxygen under a pressure that is close to the atmospheric pressure. Discharge plasma generated through application of a pulsed electric field between the opposed electrodes is brought into contact with the glass substrates. According to the configuration, multiple processes can be integrated into one process. This allows a large area processing and speedup of processes.

### RELATED ART DOCUMENT

### Patent Document

Patent Document 1: Japanese Unexamined Patent Application Publication No. 2002-143795

### PROBLEM TO BE SOLVED BY THE INVENTION

The technology in patent document 1 is for high-speed cleaning of organic stains on the glass substrates for the liquid crystal panel. Therefore, the plasma cleaning is performed under a specific condition (in the atmosphere including 4 or higher percentage by volume of oxygen). According to the plasma cleaning disclosed in patent document 1, it is difficult to sufficiently dissolve or remove foreign substances strongly stuck to surfaces of the glass substrate for the liquid crystal panel. It is difficult to reduce a percent defective due to the foreign substances.

### DISCLOSURE OF THE PRESENT INVENTION

The present invention was made in view of the above circumstances. An object is to improve yield of liquid crystal panels.

### MEANS FOR SOLVING THE PROBLEM

A method of producing a display panel according to the present invention includes a wet cleaning step, a plasma cleaning step, and a polarizing plate bonding step. The wet cleaning step is for cleaning a surface of a display board through wet cleaning. The plasma cleaning step is for applying plasma to the surface of the display board for cleaning the surface. The plasma cleaning step is performed at least one of before and after the wet cleaning step. The polarizing plate bonding step is for bonding a polarizing plate to the surface of the display board after the wet cleaning step and the plasma cleaning step.

In the wet cleaning step, the surface of the display board is cleaned through the wet cleaning. As a result, foreign substances adhering to the surface of the display board are removed. In the wet cleaning step with properly selected cleaning method and cleaning solution, water soluble foreign substances and oil soluble foreign substances adhering to the surface of the display board are efficiently removed. In the plasma cleaning step, the surface of the display board is cleaned with the plasma applied to the surface. As a result, foreign substances stuck to the surface of the display board are removed. In the plasma cleaning step, foreign substances that are strongly stuck to the surface of the display board and difficult to dissolve or remove in the wet cleaning step are efficiently dissolved or removed.

The wet cleaning step and the plasma cleaning step that is a dry cleaning are performed prior to the polarizing plate bonding step. Therefore, the foreign substances are less likely to remain between the polarizing plate and the display board in the step of bonding the polarizing plate to the surface of the display board. Display deficiencies due to the foreign substances between the polarizing plate and the display board are less likely to occur and thus the produced display panel has a high non-defective rate. Furthermore, the plasma cleaning step is performed prior to the polarizing plate bonding step. This improves the adhesion of the polarizing plate bonded to the surface of the display board in the polarizing plate bonding step. Therefore, bubbles are less likely to be produced between the polarizing plate and the display board. Deficiencies due to the bubbles are less likely to occur and thus a step for removing the bubbles after the polarizing plate bonding step is not required. This reduces the production cost of the display panel.

The following configuration may be preferable for embodiments of the present invention.

(1) The plasma cleaning step is performed before the wet cleaning step. In the plasma cleaning step, the foreign substances that are strongly stuck to the surface of the display board are separated from the surface through application of the plasma. The wet cleaning step is performed after the plasma cleaning step. Therefore, the foreign substances separated from the surface of the display board are efficiently removed. The foreign substances that are separated from the surface of the display board in the plasma cleaning step are less likely to remain on the surface of the display board in the polarizing plate bonding step. Therefore, the produced display panel has a high non-defective rate.

(2) In the wet cleaning step and the plasma cleaning step, at least an entire area of the display board in a display area in which an image is displayed is cleaned. With the entire area of the display board at least in a display area in which an image is displayed cleaned through the wet cleaning and the plasma cleaning, the foreign substances are less likely to be sandwiched between the polarizing plate and the display board in the display area. Furthermore, display deficiencies due to the foreign substances are less likely to occur.

(3) In the plasma cleaning step, the plasma is applied through a plasma applying device used for application of the plasma with an output thereof set in a range from 200 W to 500 W. If the output of the plasma applying device used for the application of the plasma is below 200 W, the foreign substances that are strongly stuck to the surface of the display board are less likely to be sufficiently dissolved or separated. If the output is over 500 W, the applied plasma may cause adverse effects on structures (e.g. traces) formed on the display board for displaying an image. With the output of the plasma applying device used for the application of the plasma in the plasma cleaning step set in the range from 200 W to 500 W, the foreign substances that are strongly stuck to the surface of the display board can be sufficiently dissolved or separated. Furthermore, the applied plasma is less likely to cause adverse effects on the structures (e.g., traces) formed on the display board for displaying an image.

### ADVANTAGEOUS EFFECT OF THE INVENTION

According to the present invention, the yield of the display panel improves.

### BRIEF DESCRIPTION OF THE DRAWINGS

FIG. 1 is a schematic cross-sectional view illustrating a cross-sectional configuration of a liquid crystal panel produced by a method of producing the liquid crystal panel according to a first embodiment of the present invention.

FIG. 2 is a magnified plan view illustrating a planar configuration of a display area of an array board included in the liquid crystal panel.

FIG. 3 is a magnified plan view illustrating a planar configuration of a display area of a CF board included in the liquid crystal panel.

FIG. 4 is a diagram illustrating processes included in the method of producing the liquid crystal panel.

FIG. 5 is a diagram schematically illustrating a remote-type plasma cleaning device.

FIG. 6 is a diagram schematically illustrating a direct-type plasma cleaning device.

FIG. 7 is a diagram including a picture of an outer surface of each board before a plasma cleaning process, a picture of the outer surface of each board after the plasma cleaning process, and a picture of the outer surface of each board after a wet cleaning process.

FIG. 8 is a diagram illustrating processes included in a method of producing a liquid crystal panel according to a second embodiment of the present invention.

### MODE FOR CARRYING OUT THE INVENTION

### First Embodiment

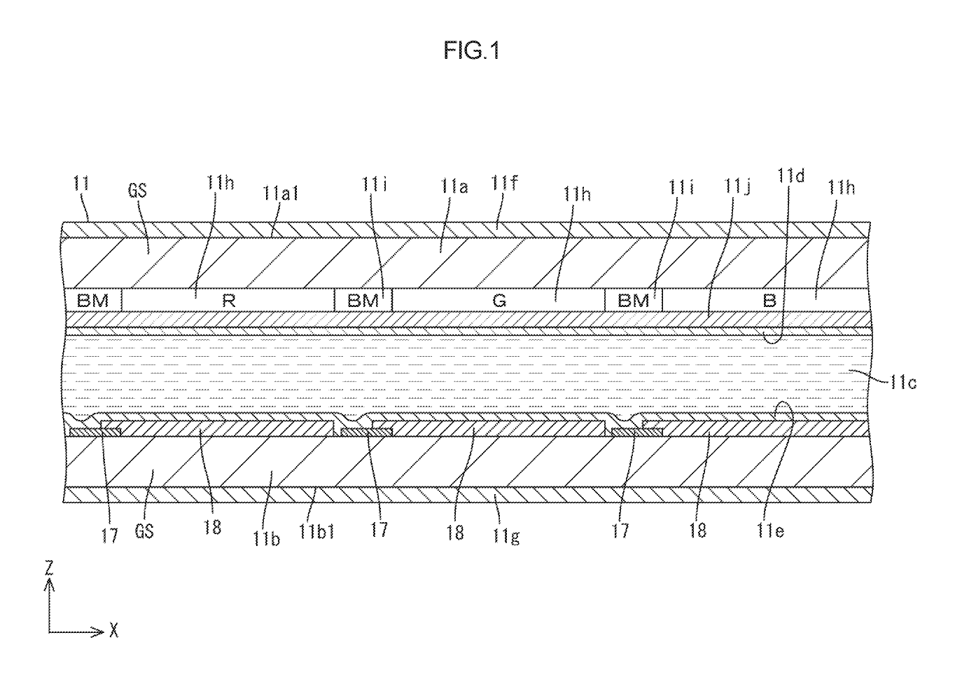

A first embodiment of the present invention will be described with reference to FIGS. 1 to 7. This embodiment is an example of a method of producing a liquid crystal panel 11 used in a liquid crystal display device (a display device). X-axes, Y-axes, and Z-axes may be present in the drawings. The axes in each drawing correspond to the respective axes in other drawings.

A configuration of a liquid crystal panel 11 will be described. As illustrated in FIG. 1, the liquid crystal panel 11 includes a pair of transparent boards 11a and 11b (with high light transmissivity) and a liquid crystal layer 11c between the boards 11a and 11b. The liquid crystal layer 11c includes liquid crystal molecules that are substances having optical properties that changes according to application of electric field. The boards 11a and 11b are bonded together with a sealing adhesive that is not illustrated with a cell gap corresponding to a thickness of the liquid crystal layer 11c. The liquid crystal panel 11 is a twisted nematic (TN) type. The boards 11a and 11b include substantially transparent glass substrates GS, respectively. Multiple films are formed in layers on the glass substrates GS, respectively, with a known photolithography method. One of the boards 11a and 11b on the front side is a CF board (a display board, a counter board) 11a and the other board is on the rear side (the back side) is an array board (a display board, an element board, an active matrix board) 11b. Polarizing plates 11f and 11g are bonded to outer surfaces (front surfaces) slab and 11b1 of the board 11a and 11b, respectively. Namely, the outer surfaces 11a1 and 11b1 of the boards 11a and 11b are bonding surfaces to which the polarizing plates 11f and 11g are bonded. The polarizing plates 11f and 11g are orientated in crossed nicol arrangement in which polarizing directions are perpendicular to each other (different by 90 degrees). Namely, the liquid crystal panel 11 is in normally black mode in which the light transmissivity is the minimum when the liquid crystal panel 11 is turned off (no voltage is applied to pixel electrodes 18) and a display is in black. Alignment films 11d and 11e for aligning the liquid crystal molecules in the liquid crystal layer 11c are formed on inner surfaces of the boards 11a and 11b, respectively.

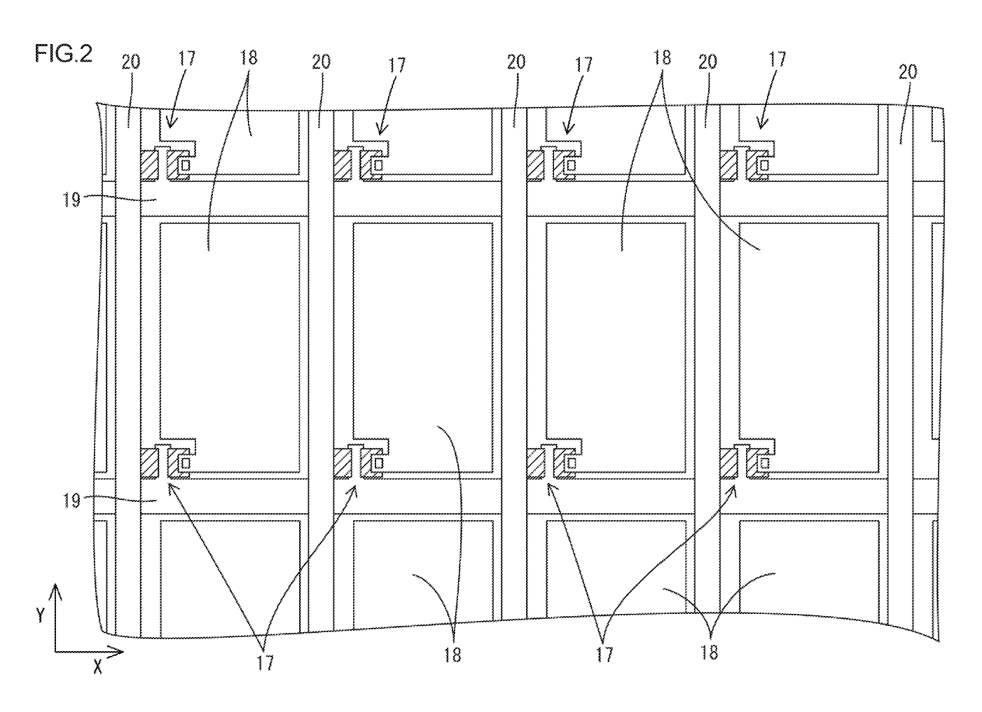

As illustrated in FIGS. 1 and 2, on an inner surface (on a liquid crystal layer 11c side, on a side opposite to the CF board 11a) of the array board 11b, TFTs (thin film transistors) 17, which are switching components, and pixel electrodes 18 are arranged in a matrix in a display area. The display area is an inner area of a screen in which images are displayed. Gate lines 19 and source lines 20 are arranged in a grid to surround the TFTs 17 and the pixel electrodes 18. Namely, the TFTs 17 and the pixel electrodes 18 are arranged at intersections of the gate lines 19 and the source lines 20 that are arranged in the grid and in lines to form the matrix. The gate lines 19 and the source lines 20 are connected to gate electrodes and source electrodes of the TFTs 17, respectively. The pixel electrodes 18 are connected to drain electrodes of the TFTs 17. Each pixel electrode 18 has a vertically long rectangular shape in a plan view. The pixel electrodes 18 are made from a light transmissive conductive film that is made of material having high light transmissivity and conductivity such as indium tin oxide (ITO) and zinc oxide (ZnO). Capacitance lines (not illustrated) may be formed on the array board 11b. The capacitance lines may be arranged parallel to the gate lines 19 and to cross the pixel electrodes 18.

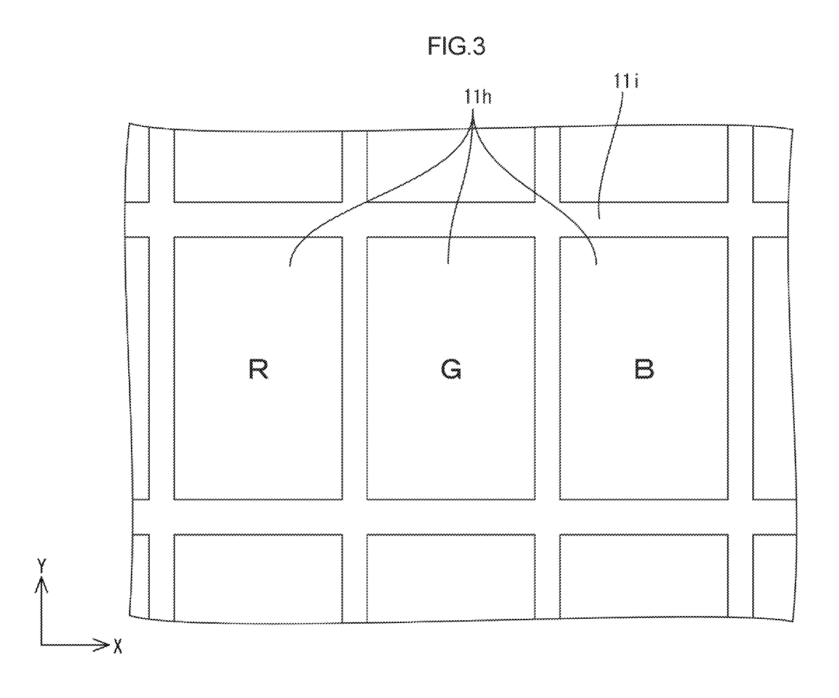

As illustrated in FIGS. 1 and 3, on an inner surface of the CF board 11a, color filters 11h are formed in the display area that is the inner area of the screen in which images are displayed. The color filters 11h include red (R), green (G), and blue (B) color portions are arranged in a matrix to overlap the pixel electrodes 18 on the arrange board 11b in a plan view. A light blocking layer having a grid shape (a black matrix) 11i is formed between the color portions included in the color filters 11h for reducing color mixture. The light blocking layer 11i is arranged to overlap the gate lines 19 and the source lines 20 in a plan view. A counter electrode 11j is formed in a solid pattern on surfaces of the color filters 11h and the light blocking layer 11i. The counter electrode 11j is opposed to the pixel electrodes 18 on the array board 11b. In the liquid crystal panel 11, as illustrated in FIGS. 1 to 3, the R (red) color portion, the G (green) color portion, the B (blue) color portion, and three pixel electrodes 18 opposed to the color portions form a display pixel that is a display unit. Each display pixel includes a red pixel including the R color portion, a green pixel including the G color portion, and a blue pixel including the B color portion. The color pixels are repeatedly arranged along a row direction (the X-axis direction) on a plate surface of the liquid crystal panel to form lines of pixels. The lines of pixels are arranged along the column direction (the Y-axis direction).

The liquid crystal panel 11 having the configuration described above is configured to display images using light emitted by a backlight unit that is an external light source, which is not illustrated. Specifically, polarizing directions of rays of the light emitted by the backlight unit are aligned when passing through the polarizing plate 11g on the rear side of the liquid crystal panel 11. Polarizing states of the rays of light, the polarizing directions of which are aligned, vary according to alignment of liquid crystal molecules in the liquid crystal layer 11c. The alignment of the liquid crystal molecules in the liquid crystal layer 11c is controlled based on potential differences between the pixel electrodes 18 and the common electrode 11j. Therefore, the polarization states of rays of transmitting light are controlled per pixel electrode 18 (per display pixel). Rays of light exiting from the liquid crystal layer 11c are tinted with colors corresponding to the color portions when the rays of light pass through the color filters 11h. The tinted rays of light pass through the polarizing plate 11f on the front side and exit to the outside. A specified color image can be displayed by individually controlling an amount of light from the liquid crystal panel 11 per display pixel.

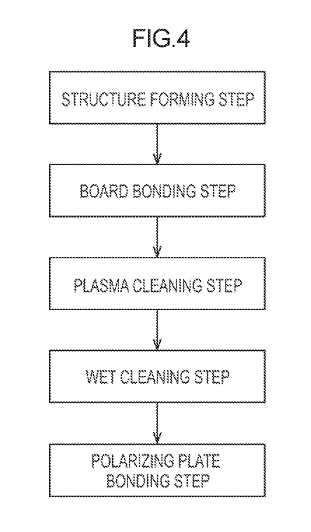

Next, the method of producing the liquid crystal panel 11 will be described. As illustrated in FIG. 4, the method of producing the liquid crystal panel 11 includes a structure forming step (a photolithography step), a board bonding step, a wet cleaning step, a dry plasma cleaning step, and a polarizing plate bonding step. The structure forming step is for forming various kinds of metal films and insulating films in layers on inner surfaces of the glass substrates GS of the CF board 11a and the array board 11B through a known photolithography method and forming various kinds of structures. The board bonding step is for bonding the CF board 11a and the array board 11b with the liquid crystal layer 11c between the CF board 11a and the array board 11b. The wet cleaning step is for wet-cleaning the outer surfaces 11a1 and 11b1 of the CF board 11a and the array board 11b. The dry plasma cleaning step is performed before the wet cleaning step. The dry plasma cleaning step is for plasma-cleaning the outer surfaces 11a1, 11b1 of the CF board 11a and the array board 11b. The polarizing plate bonding step is for bonding the polarizing plates to the outer surfaces 11a1 and 11b1 of the CF board 11a and the array board 11b. Among the steps, the wet cleaning step and the plasma cleaning step will be described in detail below.

The wet cleaning step is performed after the plasma cleaning step, which will be described next, and immediately before the polarizing plate bonding step. In the wet cleaning step, the outer surfaces 11a1 and 11b1 of the CF board 11a and the array board 11b that are bonded together in the board bonding step and to which the polarizing plates 11f and 11g are bonded are entirely cleaned through wet cleaning. Through the wet cleaning, foreign substances adhering to the outer surfaces 11a1 and 11b1 are efficiently removed. The foreign substances removed from the outer surfaces 11a1 and 11b1 of the CF board 11a and the array board 11b in the wet cleaning step are mainly water-soluble foreign substances and oil-soluble foreign substances, which adhere to the outer surfaces 11a1 and 11b1 through the structure forming step and the board bonding step. In the wet cleaning step, the outer surfaces 11a1 and 11b1 of the CF board 11a and the array board 11b are entirely cleaned through the wet cleaning. Therefore, not only an entire area of the display area in which images are displayed but also an entire area of non-display area in which images are not displayed are cleaned.

Methods of cleaning that may be used in the wet cleaning step include polishing, brushing, hot water washing, and steam washing. In the polishing, the outer surfaces 11a1 and 11b1 of the CF board 11a and the array board 11b are physically polished with a polishing sheet to remove foreign substances adhering to the outer surfaces 11a1 and 11b1. Then, the foreign substances are rinsed off the outer surfaces 11a1 and 11b1 with cleaning solution such as pure water and ultrapure water. In the brushing, a rotating cleaning brush is brought into contact with the outer surfaces 11a1 and 11b1 of the CF board 11a and the array board 11b to remove foreign substances adhering to the outer surfaces 11a1 and 11b1. Then, the foreign substances are rinsed off the outer surfaces 11a1 and 11b1 with cleaning solution such as ultrapure water. In the hot water washing, hot water is injected through a nozzle and sprayed on the outer surfaces 11a1 and 11b1 of the CF board 11a and the array board 11b to rinse the foreign substances off the outer surfaces 11a1 and 11b1. In the steam washing, a cleaning solution such as pure water and ultrapure water is vaporized by a steam generator (a steam boiler) and steam for cleaning is produced. The steam is applied to the outer surfaces 11a1 and 11b1 of the CF board 11a and the array board 11b under pressure to remove the foreign substances off the outer surfaces 11a1 and 11b1. The pure water or the ultrapure water used as the cleaning solution as described above is preferable for removing soluble foreign substance off the outer surfaces 11a1 and 11b1 of the CF board 11a and the array board 11b. Other than the pure water and the ultrapure water, an organic solvent may be used for the cleaning solution. The organic solvent is preferable for removing oil soluble foreign substances off the outer surfaces 11a1 and 11b1 of the CF board 11a and the array board 11b.

The plasma cleaning step is performed prior to the wet cleaning step described above. In the plasma cleaning step, plasma is applied to the outer surfaces 11a1 and 11b1 of the CF board 11a and the array board 11b to carry out the plasma cleaning on enter areas of the outer surfaces 11a1 and 11b1. In this step, foreign substances that are strongly stuck to the outer surfaces 11a1 and 11b1 and difficult to dissolve or remove in the wet cleaning step described above can be efficiently dissolved or removed. The foreign substances dissolved or removed in the plasma cleaning step include acrylic resin substances, rubber substances, and glass cullet. Such foreign substances are strongly stuck to the outer surfaces 11a1 and 11b1 of the CF board 11a and the array board 11b in the structure forming step or the board bonding step. In the plasma cleaning step, the entire areas of the outer surfaces 11a1 and 11b1 of the CF board 11a and the array board 11b are cleaned. Therefore, not only the display area in which images are displayed but also the non-display area in which images are not displayed are entirely cleaned.

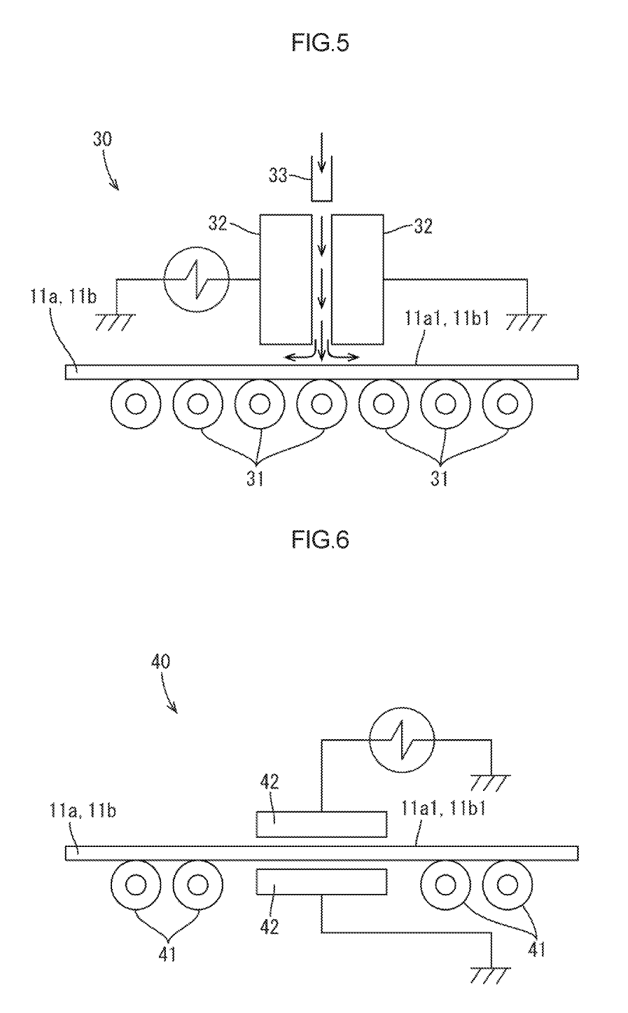

In the plasma cleaning step, an atmospheric pressure plasma cleaning device configured to apply atmospheric pressure plasma is used. An example of the atmospheric pressure plasma is a remote-type plasma cleaning device 30. As illustrated FIG. 5, the remote-type plasma cleaning device 30 includes feeders 31, a pair of electrodes 32, and an air nozzle 33. The feeders 31 feed the CF board 11a and the array board 11b. The electrodes 32 are opposed to each other on a side opposite from the feeders 31 with respect to the CF board 11a and the array board 11b that are being fed. The air nozzle 33 is disposed on the side opposite from the feeders 31 with respect to the electrodes 32. The air nozzle 33 injects purified and compressed air to space between the electrodes 32. According to the remote-type plasma cleaning device 30, when the compressed air injected from the air nozzle 33 is passed between the electrodes 32 while an electric field is generated between the electrodes 32, plasma is produced. The produced plasma is applied to the outer surfaces 11a1 and 11b1 of the CF board 11a and the array board 11b. Other than the remote-type plasma cleaning device 30, a direct-type plasma cleaning device 40 may be used for the plasma cleaning device. As illustrated in FIG. 6, the direct-type plasma cleaning device 40 includes feeders 41 and a pair of electrodes 42. The feeders 31 feed the CF board 11a and the array board 11b. The electrodes 42 are disposed to sandwich the CF board 11a and the array board 11b that are being fed from sides with respect to the thickness direction. According to the direct-type plasma cleaning device 40, when an electric filed is generated between the electrodes 42, plasma is produced. The produced plasma is applied to the outer surfaces 11a1 and 11b1 of the CF board 11a and the array board 11b.

To perform the plasma cleaning step using the plasma cleaning device described above, it is preferable to set an output of the plasma cleaning device in a range from 200 W to 500 W. If the output of the plasma applying device is below 200 W, dissolution or removal of the foreign substances strongly stuck to the outer surfaces 11a1 and 11b1 of the CF board 11a and the array board 11b may not be sufficiently taken place. If the output is over 500 W, the applied plasma may cause adverse effect on the structures (TFTs 17, pixel electrodes 18, lines 19 and 20) formed on the CF board 11a and the array board 11b for displaying images. With the output of the plasma applying device set in the range from 200 W to 500 W, as described above, the dissolution or the removal of the foreign substances strongly stuck to the outer surfaces 11a1 and 11b1 of the CF board 11a and the array board 11b is sufficiently taken place. Furthermore, the applied plasma is less likely to cause the adverse effect on the structures formed on the CF board 11a and the array board 11b for displaying images. In the remote-type plasma cleaning device 30, it is preferable to set a feeding speed for feeding the CF board 11a and the array board 11b in a range from 30 mm/sec to 200 mm/sec. Furthermore, it is preferable to set a distance between the CF board 11a and the array board 11b and the electrodes 32 (a work distance) in a range from 3 mm to 50 mm. Still furthermore, it is preferable to set a flow rate of the compressed air injected from the air nozzle 33 in a range from 51/min to 301/min. In general, to improve the hydrophilicity or the adhesion at the surfaces of the boards, the output of the plasma applying device for applying the plasma is set at about 50 W, that is, a low level.

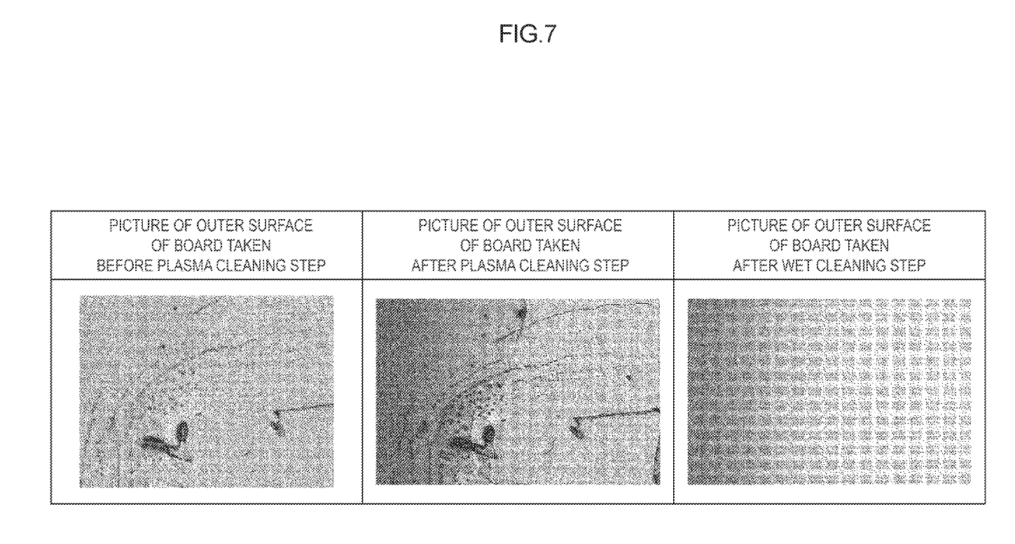

According to the method of producing the liquid crystal panel 11, the plasma cleaning step is performed after the bonding step is performed. Therefore, the foreign substances strongly stuck to the outer surfaces 11a1 and 11b1 of the CF board 11a and the array board 11b can be dissolved or removed. Even if the foreign substances on the outer surfaces 11a1 and 11b1 of the CF board 11a and the array board 11b are not removed, as long as the foreign substances are dissolved, sizes of the foreign substances are reduced and thus possibilities of detection of display deficiencies decrease. According to the configuration, the produced liquid crystal panel 11 has a high non-defective rate. A picture on the left in FIG. 7 is a picture of the outer surfaces 11a1 and 11b1 of the boards 11a and 11b taken before the plasma cleaning step. A picture in the middle in FIG. 7 is a picture of the outer surfaces 11a1 and 11b1 of the boards 11a and 11b taken after the plasma cleaning step. According to the picture in the middle, the sizes of the foreign substances are reduced in comparison to those before the plasma cleaning step. When the wet cleaning step is performed after the plasma cleaning step, the foreign substances removed from the outer surfaces 11a1 and 11b1 of the CF board 11a and the array board 11b in the plasma cleaning step are efficiently eliminated. Therefore, the foreign substances are less likely to adhere to the outer surfaces 11a1 and 11b1 again. Furthermore, the water soluble foreign substances and the oil soluble foreign substances are efficiently eliminated. A picture on the right in FIG. 7 is a picture of the outer surfaces 11a1 and 11b1 of the boards 11a and 11b taken after the wet cleaning step. According to the picture on the right in FIG. 7, little foreign substance exists. In FIG. 7, a pattern including rectangles arranged in a matrix is formed by shadows of the color filters 11h. When the polarizing plates bonding step is performed after the wet cleaning step, the polarizing plates 11f and 11g are bonded to the outer surfaces 11a1 and 11b1 of the CF board 11a and the array board 11b, respectively. About entire areas of the outer surfaces 11a1 and 11b1 of the CF board 11a and the array board 11b are in a state that the foreign substances are removed through the plasma cleaning step and the wet cleaning step described above. Therefore, the foreign substances are less likely to remain between the outer surfaces 11a1 and 11b1 and the respective polarizing plates 11f and 11g that are bonded to the outer surfaces 11a1 and 11b1. Display deficiencies due to the foreign substances between the outer surfaces 11a1 and 11b1 of the CF board 11a and the array board 11b and the polarizing plates 11f and 11g are less likely to occur and thus the produced liquid crystal panel 11 has a high non-defective rate. Specifically, a defective rate due to the foreign substances when a method without the plasma cleaning step is used is about 2% to 3%. When the method including the plasma cleaning step is used, the defective rate due to the foreign substances is about 1.5% to 2.5%. Namely, about 0.5% of improvement is achieved in the defective rate due to the foreign substances. Through the plasma cleaning step, the adhesion of the polarizing plates 11f and 11g to the outer surfaces 11a1 and 11b1 of the CF board 11a and the array board 11b in the polarizing plate bonding step improves. Bubbles are less likely to form between the polarizing plates 11f and 11g and the CF board 11a and the array board 11b. Therefore, deficiencies due to the bubbles are less likely to occur and a step for removing such bubbles after the polarizing plate bonding step is not required. This can reduce a production cost of the liquid crystal panel 11.

As described above, the method of producing the liquid crystal panel (a display panel) 11 according to this embodiment includes the wet cleaning step, the plasma cleaning step, and the polarizing plate bonding step. In the wet cleaning step, the outer surfaces (surfaces) 11a1 and 11b1 of the CF board 11a and the array board 11b (display boards) are cleaned through wet cleaning. In the plasma cleaning step, which may be performed at least before or after the wet cleaning step, the outer surfaces 11a1 and 11b1 of the CF board 11a and the array board 11b are cleaned by applying the plasma to the outer surfaces 11a1 and 11b1. In the polarizing plate bonding step performed after the wet cleaning step and the plasma cleaning step, the polarizing plates 11f and 11g are bonded to the outer surfaces 11a1 and 11b1 of the CF board 11a and the array board 11b.

In the wet cleaning step in which the outer surfaces 11a1 and 11b1 of the CF board 11a and the array board 11b through the wet cleaning, the foreign substances adhering to the outer surfaces 11a1 and 11b1 of the CF board 11a and the array board 11b are removed. In the wet cleaning step with properly selected cleaning method and cleaning solution, the water soluble foreign substances and the oil soluble foreign substances adhering to the outer surfaces 11a1 and 11b1 of the CF board 11a and the array board 11b are efficiently removed. In the plasma cleaning step, the outer surfaces 11a1 and 11b1 of the CF board 11a and the array board 11b are cleaned with the plasma applied to the outer surfaces 11a1 and 11b1. As a result, the foreign substances stuck to the outer surfaces 11a1 and 11b1 of the CF board 11a and the array board 11b are removed. In the plasma cleaning step, the foreign substances that are strongly stuck to the outer surfaces 11a1 and 11b1 of the CF board 11a and the array board 11b and difficult to dissolve or remove in the wet cleaning step are efficiently dissolved or removed.

As described above, the wet cleaning step and the plasma cleaning step, which uses a dry cleaning method, are performed prior to the polarizing plate bonding step. Therefore, the foreign substances are less likely to remain between the polarizing plates 11f and 11g and the CF board 11a and the array board 11b when the polarizing plates 11f and 11g are bonded to the outer surfaces 11a1 and 11b1 of the CF board 11f and the array board 11b. Display deficiencies due to the foreign substances between the polarizing plates 11f and 11g and the CF board 11a and the array board 11b are less likely to occur and thus the produced liquid crystal panel 11 has a high non-defective rate. Furthermore, the plasma cleaning step is performed prior to the polarizing plate bonding step. Therefore, the adhesion of the polarizing plat 11f and 11g to the outer surfaces 11a1 and 11b1 of the CF board 11a and the array board 11b improves in the polarizing plate bonding step. Bubbles are less likely to be produced between the polarizing plates 11f and 11g and the CF board 11a and the array board 11b. Therefore, the deficiencies due to the bubbles are less likely to occur. A step for removing such bubbles after the polarizing plate bonding step is not required. This reduces the production cost of the liquid crystal panel 11.

The plasma cleaning step is performed prior to the wet cleaning step. In the plasma cleaning step, the foreign substances strongly stuck to the outer surfaces 11a1 and 11b1 of the CF board 11a and the array board 11b are separated from the outer surfaces 11a1 and 11b1 through the application of the plasma. In the wet cleaning performed after the plasma cleaning, the foreign substances separated from the outer surfaces 11a1 and 11b1 of the CF board 11a and the array board 11b are efficiently removed. The foreign substances that are separated from the outer surfaces 11a1 and 11b1 of the CF board 11a and the array board 11b in the plasma cleaning step are less likely to remain on the outer surfaces 11a1 and 11b1 of the CF board 11a and the array board 11b. Therefore, the produced liquid crystal panel 11 has a high non-defective rate.

In the wet cleaning step and the plasma cleaning step, the entire areas of the CF board 11a and the array board 11b in at least the display area in which images are displayed are cleaned. With the entire areas in the display area in which images are displayed cleaned through the wet cleaning and the plasma cleaning, the foreign substances are less likely to be sandwiched between the polarizing plates 11f and 11g and the CF board 11a and the array board 11b. Therefore, display deficiencies due to such foreign substances are less likely to occur.

In the plasma cleaning step, the outputs of the plasma applying devices 30 and 40 used for application of the plasma are set in the range from 200 W to 500 W and the plasma is applied. If the outputs of the plasma applying devices 30 and 40 used for the application of the plasma are below 200 W, the foreign substances that are strongly stuck to the outer surfaces 11a1 and 11b1 of the CF board 11a and the array board 11b may not be sufficiently dissolved or separated. If the outputs are over 500 W, the applied plasma may cause adverse effects to the structures (e.g., lines 19 and 20) formed on the CF board 11a and the array board 11b for displaying images. With the outputs of the plasma applying devices 30 and 40 used for application of the plasma in the plasma cleaning step in the range from 200 W to 500 W, the foreign substances that are strongly stuck to the outer surfaces 11a1 and 11b1 of the CF board 11a and the array board 11b are sufficiently dissolved or separated. Furthermore, the applied plasma is less likely to cause the adverse effects on the structures (e.g., lines 19 and 20) formed on the CF board 11a and the array board 11b for displaying images.

### Second Embodiment

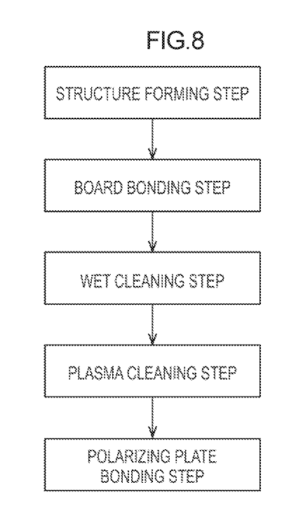

A second embodiment will be described with reference to FIG. 8. In the second embodiment, the plasma cleaning step and the wet cleaning step are performed in an opposite sequence from the first embodiment. Other configurations, functions, and effects are similar to those of the first embodiment and thus will not be described.

In a method of producing a liquid crystal panel according to this embodiment, as illustrated in FIG. 8, the wet cleaning step is performed after the board bonding step and the polarizing plate bonding step is performed after the plasma cleaning step that is performed after the wet cleaning step. Although the plasma cleaning step is performed after the wet cleaning step, the foreign substances that are strongly stuck to the outer surfaces of the boards are dissolved through the application of the plasma. The sizes of the foreign substances decrease. Therefore, possibilities of detection of display deficiencies decrease and thus the yield improves.

### Third Embodiment

A third embodiment will be described. In the third embodiment, the outputs of the plasma cleaning devices used in the plasma cleaning step are altered from those of the second embodiment. Other configurations, functions, and effects are similar to those of the second embodiment and thus will not be described.

In the plasma cleaning step according to this embodiment, the outputs of the plasma cleaning devices are set in a range from 50 W to 200 W, which are lower than the outputs of the plasma applying devices used in the plasma cleaning step in the first embodiment or the second embodiment (in the range from 200 W to 500 W). The plasma cleaning step is performed after the wet cleaning step and immediately before the polarizing plate bonding step. According to the configuration, the adhesion of the polarizing plates bonded to the outer surfaces of the board in the polarizing plate bonding step improves. Bubbles are less likely to be produced between the polarizing plates and the boards and thus deficiencies due to the bubbles are less likely to occur. Furthermore, a step for removing the bubbles after the polarizing plate bonding step is not required. This reduces the production cost of the liquid crystal panel.

### Other Embodiments

The present invention is not limited to the embodiments, which have been described using the foregoing descriptions and the drawings. For example, embodiments described below are also included in the technical scope of the present invention.

(1) In each of the above embodiment sections, the method including the plasma cleaning step performed before or after the wet cleaning step is described. However, the plasma cleaning step may be performed before and after the wet cleaning step.

(2) The present invention may be applied to a method of producing a liquid crystal panel including polarizing plates bonded to entire areas of outer surfaces of boards. The present invention can be applied to a method of producing a liquid crystal panel including polarizing plates bonded to most of central areas of outer surfaces of boards (including at least entire areas in a display area) but not to peripheral areas thereof.

(3) In the first embodiment, the plasma cleaning step uses the atmospheric pressure plasma cleaning. Other than the atmospheric pressure plasma cleaning, a vacuum plasma cleaning step may be performed.

(4) In the first embodiment section, the polishing, the brushing, the hot water washing, and the steam washing are provided as examples of the wet cleaning step. However, a wet cleaning step including ultrasonic cleaning, soaking, bubbling, or electrolyte cleaning may be performed.

(5) In each of the above embodiment sections, the method of producing the liquid crystal panel including a pair of polarizing plates that are orientated in crossed nicol arrangement is described. However, the present invention can be applied to a method of producing a liquid crystal panel including a pair of polarizing plates orientated in parallel nicol arrangement in which polarizing directions are parallel to each other so that the light transmissivity is at the maximum when the liquid crystal panel is turned off (no voltages are applied to pixel electrodes) and in normally white mode in which a display is in white.

(6) In each of the above embodiment sections, the method of producing the transmissive liquid crystal panel is described. However, the present invention can be applied to a method of producing a semi-transmissive liquid crystal panel or a reflective liquid crystal panel.

(7) In each of the above embodiment sections, the method of producing the liquid crystal panel is described. However, the present invention can be applied to a method of procuring an organic EL panel. Specifically, the wet cleaning step and the plasma cleaning step may be performed before a polarizing plate bonding step for bonding circular polarizing plates to the organic EL panel for reducing reflection.

### EXPLANATION OF SYMBOLS

11: liquid crystal panel, 11a: CF board (display board), 11a1: outer surface (surface), 11b: array board (display board), 11b1: outer surface (surface), 11f, 11g: polarizing plate, 30: remote-type plasma cleaning device (plasma cleaning device), 40: direct-type plasma cleaning device (plasma cleaning device

1: A method of producing a display panel comprising:
a wet cleaning step for cleaning a surface of a display board through wet cleaning;
a plasma cleaning step for applying plasma to the surface of the display board for cleaning the surface, the plasma cleaning step being performed at least one of before and after the wet cleaning step; and
a polarizing plate bonding step for bonding a polarizing plate to the surface of the display board after the wet cleaning step and the plasma cleaning step.

2: The method according to claim 1, wherein the plasma cleaning step is performed before the wet cleaning step.

3: The method according to claim 1, wherein at least an entire area of the display board in a display area in which an image is displayed is cleaned in the wet cleaning step and the plasma cleaning step.

4: The method according to claim 1, wherein the plasma is applied with a plasma applying device used for application of the plasma with an output thereof set in a range from 200 W to 500 W.
